(19) United States
(12) Patent Application Publication
(10) Pub. No.: US 2025/0033536 A1
(43) Pub. Date: Jan. 30, 2025

(54) RAIL, RAIL PAIR AND SEAT LONGITUDINAL ADJUSTMENT DEVICE

(71) Applicant: Adient US LLC, Plymouth, MI (US)

(72) Inventor: Erik SPRENGER, Wermelskirchen (DE)

(73) Assignee: Adient US LLC, Plymouth, MI (US)

(21) Appl. No.: 18/713,876

(22) PCT Filed: Nov. 29, 2022
(86) PCT No.: PCT/IB2022/061515

§ 371 Date: May 28, 2024

(30) Foreign Application Priority Data
Dec. 3, 2021 (DE) 10 2021 213 780.6
Mar. 7, 2022 (DE) 10 2022 202 260.2

(51) Int. Cl. B60N 2/07

(52) U.S. Cl. CPC B60N 2/0715

(57) ABSTRACT

A rail for a rail pair of a seat longitudinal adjustment device may have at least two side walls and a web connecting the side walls. At least one of the side walls may have a receiving profile for receiving and guiding a connection cable or cable bundle or cable housing along a longitudinal extension of the rail. A seat longitudinal adjustment device having the rail pair is also disclosed.

The invention relates to a rail for a rail pair of a longitudinal seat adjustment device, for example, of a vehicle seat. The invention further relates to a rail pair having such a rail and a longitudinal seat adjustment device having such a rail pair.

A longitudinal seat adjustment device generally comprises two rail pairs which are arranged with spacing from each other and which are each constructed from two rails, an upper rail which is associated with the seat and a lower rail which is associated with the base of a vehicle. The longitudinal seat adjustment device is, for example, electrically adjustable. For this purpose, the longitudinal seat adjustment device comprises, for example, an adjustment unit and a drive unit for electrically driving the adjustment unit, wherein a power supply of the drive unit is carried out via at least one connection cable. With a long adjustment path, the connection cable must also be able to be moved safely and with little friction through a rail profile.

Furthermore, for example, a use of sliding contacts in rail profiles is known from the prior art. Via the sliding contacts, power is supplied to a rail runner of a rail pair.

An object of the present invention is to provide a rail for a rail pair of a longitudinal seat adjustment device, which rail is improved compared with the prior art, wherein a connection cable and/or a cable arrangement, for example, a cable bundle or cable housing, can also be carried in a safe and friction-free manner. Furthermore, an object of the present invention is to provide a rail pair which is improved compared with the prior art and an improved longitudinal seat adjustment device.

With regard to the rail, the object is achieved according to the invention with the features of claim 1. With regard to the rail pair, the object is achieved according to the invention with the features of claim 14. With regard to the longitudinal seat adjustment device, the object is achieved according to the invention with the features of claim 15.

The rail according to the invention, for example, a lower rail or base rail, for a rail pair of a longitudinal seat adjustment device of a seat, in particular vehicle seat, is configured, for example, in a substantially U-shaped manner, wherein the rail has at least two side walls and a web which connects the side walls, wherein at least one of the side walls has a receiving profile for receiving and guiding a connection cable or cable bundle or cable housing along the longitudinal extent of the rail.

With a long adjustment path, the connection cable, the cable bundle or the cable housing must be able also to be moved safely and with little friction through a rail profile. With the rail according to the invention, an extremely friction-free and safe guiding of the connection cable or a cable strand or cable harness comprising a plurality of connection cables is achieved.

With the rail according to the invention, the guiding of the connection cable can also be carried out over comparatively long adjustment paths. A rail pair which has the rail according to the invention may, for example, be constructed to cover a plurality of seat rows in a vehicle. A movable rail, for example, a so-called rail runner and/or an upper rail, of the rail pair may, for example, travel an adjustment path of at least 1300 mm. In this instance, it is ensured that the movable rail is supplied with power over the entire length of the rail pair.

For example, the rail according to the invention is a lower rail which is secured to the vehicle, also referred to as a base rail. The movable rail, also referred to as a rail runner, is movable relative to the lower rail. The rail runner is, for example, coupled to a seat, in particular a vehicle seat. In and/or on the seat, for example, safety components are arranged, such as, for example, airbags, controllable belt tensioners and/or belt alarms or other safety-relevant functional components. By means of the rail according to the invention, in particular lower rail, having a receiving profile, a power supply to the seat is ensured regardless of an adjustment and/or position of the seat or the movable rail along the lower rail. The connection cable, cable bundle or cable housing can thus be guided in a safe manner through the lower rail to the movable rail and coupled to the seat.

The receiving profile is, for example, in the form of a dovetail profile. Alternatively, the receiving profile may be in the form of a hollow member, in particular a hollow bar. The hollow member or the hollow bar may be constructed to be frustoconical in cross section. Alternatively, the receiving profile is configured in a tub-like manner, for example, in the form of a groove or a channel. The receiving profile is, for example, a profiled bar integrated in the rail. The receiving profile is, for example, configured to be substantially C-shaped, U-shaped or J-shaped in cross section. In order to save material and to reduce production steps, the receiving profile is configured to be open at one side, in particular at a side which is directed into an interior of the rail. The receiving profile is connected to the inner space.

Alternatively, the receiving profile may naturally be a completely closed profile.

In another embodiment, the receiving profile extends partially over the longitudinal extent of the rail or over an entire length of the rail. The receiving profile may be in the form of a cable guide which is integrated in the rail and which has ends which are open toward the end faces of the rail and which is provided for the introduction of a cable, cable bundle or cable housing or a plurality of cables. The receiving profile extends, for example, at least partially over the entire height of the side wall.

In another embodiment, the connection cable, cable bundle or cable housing is retained by means of the receiving profile in the rail in a force-fit. For example, the connection cable, cable bundle or cable housing can be retained in a state tensioned in the rail by means of the receiving profile. The connection cable, cable bundle or cable housing may be configured to be substantially round or flat in cross section. The shape of the receiving profile corresponds to a shape of the connection cable, the cable bundle or the cable housing.

In another embodiment, the connection cable, cable bundle or cable housing is retained in the rail in a form-fit by means of the receiving profile.

For example, a hollow pipe or a hollow bar is formed on an inner face of the side wall. In another embodiment, the receiving profile is in the form of an integrated, shaped or injected guiding groove.

Alternatively, the receiving profile may be in the form of a separate profile element which is retained on an inner side of the side wall by a material bond, a form-fit and/or a force-fit. A rail which has already been used or a rail which has already been produced can be supplied with a separate profile element which is in the form of a receiving profile. The profile element is, for example, a hollow pipe, a hollow bar, a profile groove or a profile channel.

For example, the separate receiving profile or the separate cable guide and the inner side of the side wall are configured in such a manner that they are connected to each other by means of a tongue and groove connection or a mortise joint, in particular a dovetail joint, in a form-fitting and releasable manner. For example, the separate receiving profile or the separate cable guide can be introduced or inserted at the inner side into a guiding groove in the longitudinal direction in the side wall. The separate receiving profile or the separate cable guide has an insertion profile or mortise profile which corresponds to the guiding groove in the inner side wall, in particular in the form of a dovetail.

In another embodiment, the receiving profile is integrated in the form of a guiding groove in the longitudinal direction in the side wall and constructed integrally therewith. For example, the receiving profile is configured to be substantially U-shaped or tub-shaped in cross section.

The advantages achieved with the invention involve in particular a cable receiving member and cable guide being integrated in the rail, for example, a base rail, in such a manner that no additional retention elements and securing elements are required in order to fix a connection cable or a cable arrangement to the rail. In addition, by means of the receiving profile which is integrated in the rail, the connection cable or the cable arrangement is prevented from rattling or twisting in the rail profile or in the rail pair. Furthermore, the connection cable or the cable arrangement is prevented from producing undesirable friction with other components of the rail pair. By means of the receiving profile, the connection cable can run or be guided with little friction through the rail.

Another advantage is that the connection cable is securely guided and retained in the rail and is thereby exposed to fewer vibrations. The connection cable or the cable arrangement is thereby prevented from being subject to a cable fracture as far as possible.

The rail is, for example, a base rail, also referred to as a guide rail or lower rail, wherein the web forms a rail base or a base wall, and the side walls protrude upward from the web. The side walls extend opposite each other, in particular parallel opposite each other, over the longitudinal extent of the rail. Alternatively, the rail is in the form of a seat rail, also referred to as an upper rail or rail runner.

The receiving profile is arranged internally on the at least one side wall. That is to say, the receiving profile is arranged in a receiving space formed between the side walls, for example, a hollow space or inner space.

The receiving profile and the corresponding side wall are configured in an integral manner. In particular, the rail is configured in an integral manner. For example, the rail is a punched/bent component.

In another embodiment, for example, the rail is formed from an aluminum profile or sheet metal profile, in particular from a pressed aluminum profile.

In another embodiment, the side wall is formed in such a manner that it forms at least the receiving profile and in addition a receiving space, also referred to as an inner space, for an internal rail, for example, an upper rail. The receiving profile faces in the direction of the receiving space or the inner space of the rail. For example, the dovetail-like or tub-like receiving profile is formed by an inner side of the corresponding side wall. The receiving profile is, for example, in the form of an inner wall profile of the side wall.

In another embodiment, the receiving profile is provided with a wear-resistant and/or low-friction coating and/or flocking.

In another embodiment, at least one rolling face for an adjustment element is provided in the inner space of the rail. The receiving profile is, for example, when viewed in the transverse direction of the rail, arranged to be laterally offset with respect to the rolling face. The rolling face extends partially over a longitudinal extent of the rail or over an entire length of the rail.

In another embodiment, at least one locking face or clamping face is arranged in the region of the receiving profile. The locking face or clamping face is constructed to support the connection cable, cable bundle or cable housing in the transverse direction of the rail. The side wall accordingly comprises the receiving profile and at least one locking face. The locking face protrudes, for example, from an inner side of the side wall. The locking face may also protrude from the base, that is to say, from the web of the rail. The locking face may extend in the longitudinal direction of the rail completely or partially. The locking face may be arranged in a region between the corresponding side wall and the web of the rail.

The locking face protrudes, for example, into the receiving space formed between the two side walls. The locking face is, for example, constructed to retain, for example, to clamp, and/or to tension the connection cable, cable bundle or cable housing in the receiving profile. The locking face may be in the form of an abutment face. The locking face may have a shape which corresponds to a shape of the connection cable, cable bundle or cable housing. The locking face may be part of the receiving profile. For example, the locking face may form a stop element which is opposite the side wall. Between the side wall and the locking face, the receiving profile is arranged and/or formed. The locking face and the side wall may, for example, form legs of a U-shaped receiving profile. When viewed in a vertical direction, the locking face may be configured to be shorter than the side wall. A connection of the receiving profile to the receiving space of the rail is thereby produced.

The locking face or clamping face is applied, formed, injected onto an inner face of the side wall or secured separately thereto. By means of the locking face, the connection cable, cable bundle or cable housing is retained, clamped, in particular retained in a tensioned manner. The locking face is, for example, formed with the receiving profile and/or the side wall and/or the entire rail in an integral manner. The locking face is, for example, in the form of a locking projection or a locking hook and protrudes from the side wall, in particular from the inner face of the side wall. When viewed in the transverse direction of the rail, the locking face is arranged to be laterally offset with respect to the receiving profile. The locking face extends, for example, partially over a longitudinal extent of the rail or over an entire length of the rail. The locking face may be configured integrally with the rail.

The object is further achieved according to the invention with a rail pair for a longitudinal seat adjustment device for a seat, in particular a vehicle seat, wherein the rail pair comprises at least two rails which are movable relative to each other, wherein at least one of the rails is constructed in a substantially U-shaped manner and has at least two side walls and a web which connects the side walls, wherein at least one of the side walls has a receiving profile, in particular a dovetail-like receiving profile, for receiving and guiding a cable along the longitudinal extent of the rail.

Furthermore, the object is achieved according to the invention with a longitudinal seat adjustment device for a seat, in particular a vehicle seat, wherein the longitudinal seat adjustment device comprises at least one rail pair and an electrically operable adjustment unit, wherein the rail pair comprises at least two rails which are movable relative to each other, wherein at least one of the rails is constructed in a substantially U-shaped manner and at least two side walls and a web which connects the side walls, wherein at least one of the side walls has a receiving profile, in particular a dovetail-like receiving profile, in which a connection cable is arranged and connects the adjustment unit, for example, the drive unit and/or the adjustment elements thereof, to a power source.

In another embodiment, the connection cable has a shape which corresponds to the shape of the receiving profile. For example, a cable profile is arranged in a form-fitting manner in the receiving profile as far as possible and retained in a guided manner.

In another embodiment, the cable profile of the cable has a dovetail form. The cable profile is surrounded by an aluminum profile of the receiving profile. The cable profile is thus received in the receiving profile which is in the form of an aluminum profile.

In another embodiment, the cable profile is provided at the outer side with a wear-resistant and/or low-friction coating and/or flocking. For example, the connection cable is constructed in a flocked manner in order to reduce friction between the receiving profile and the cable profile and to compensate for tolerances. A play-free and rattle-free guiding of the cable can thereby be ensured as far as possible.

In another embodiment, the rail pair comprises a cable rolling apparatus. The cable rolling apparatus is, for example, in the form of a storage cartridge or cable cartridge. The cable rolling apparatus is provided in order to roll up or unroll the connection cable when the upper rail is adjusted in the lower rail. The connection cable is thus stowed and/or stored in a cartridge outside the corresponding rail and/or the rail pair.

In another embodiment, the longitudinal seat adjustment device according to the invention comprises at least two rail pairs which are arranged with spacing from each other, wherein the rail pairs are formed in each case from an upper rail and a lower rail which are movable relative to each other. The upper rail is in the form of an in particular movable rail element. Depending on the type of construction of the longitudinal seat adjustment device, the upper rail may alternatively be configured to be fixed and the lower rail may be in the form of the above movable rail element. In this instance, the upper rail or the rail runner has a significantly shorter length than the lower rail or the guide rail. For example, the in particular fixed lower rail has a length of a few meters, in particular of from 1.5 m to 2.5 m, for example, of 2 m. The upper rail or the rail runner has a short length of less than 1 m.

In another embodiment, the longitudinal seat adjustment device for longitudinal adjustment of the seat comprises, for example, rolling elements and/or sliding rollers or sliding cylinders which are supported on the upper rail and which roll on the lower rail. The roller elements are, for example, a component of the adjustment unit. The roller elements are, for example, electrically drivable, in particular movable.

Exemplary embodiments of the invention are explained in greater detail with reference to the drawings, in which:

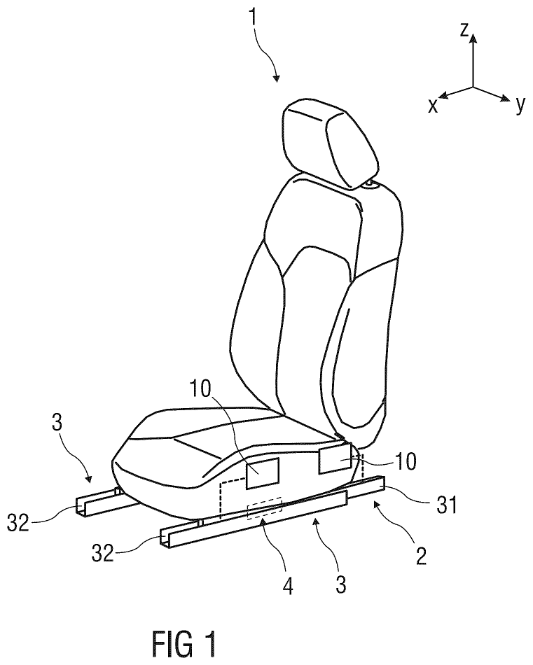

FIG. 1 shows a schematic perspective view of a seat, in particular a vehicle seat, having a longitudinal seat adjustment device comprising two rail pairs,

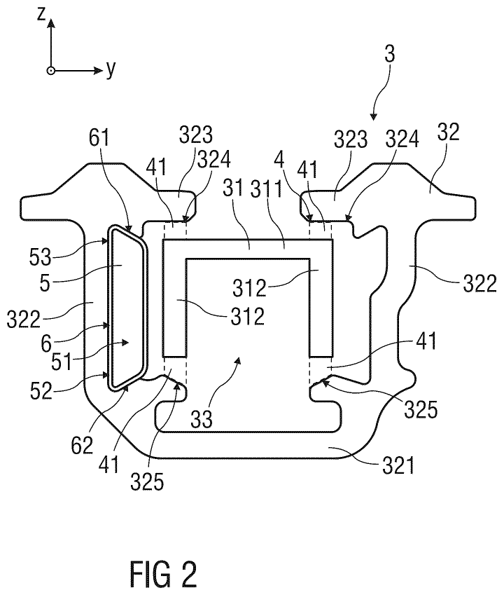

FIG. 2 shows a schematic sectioned view through a rail pair of the longitudinal seat adjustment device,

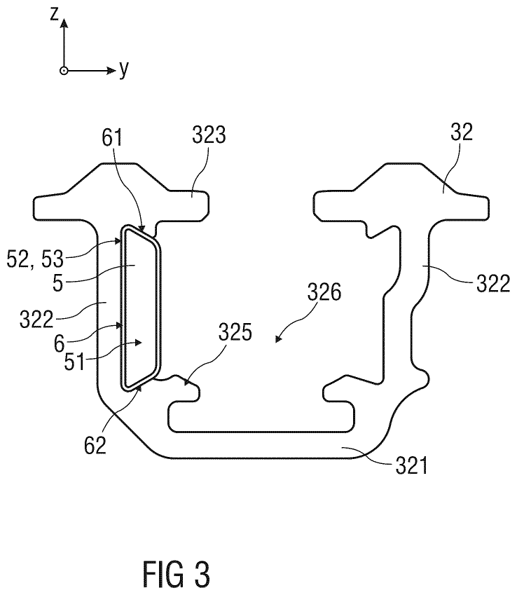

FIG. 3 shows a schematic sectioned view of a rail of the rail pair, wherein the rail has a receiving profile for receiving and guiding a cable, cable bundle or cable housing,

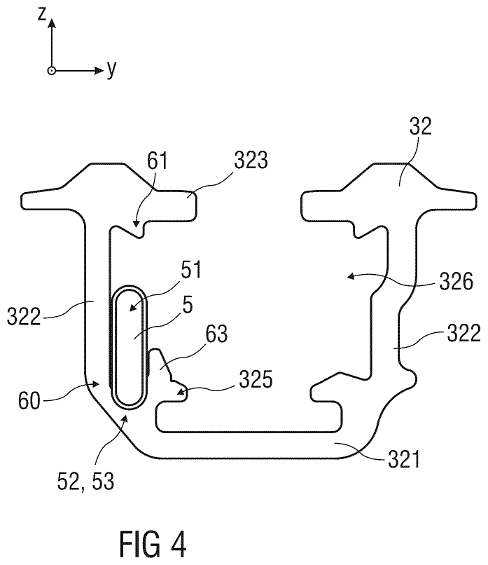

FIG. 4 shows a schematic sectioned view of another embodiment of a rail of the rail pair, wherein the rail has a receiving profile for receiving and guiding a cable, cable bundle or cable housing, and

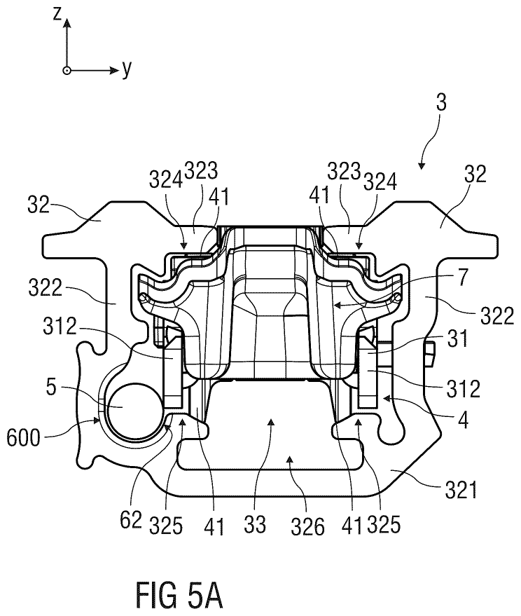

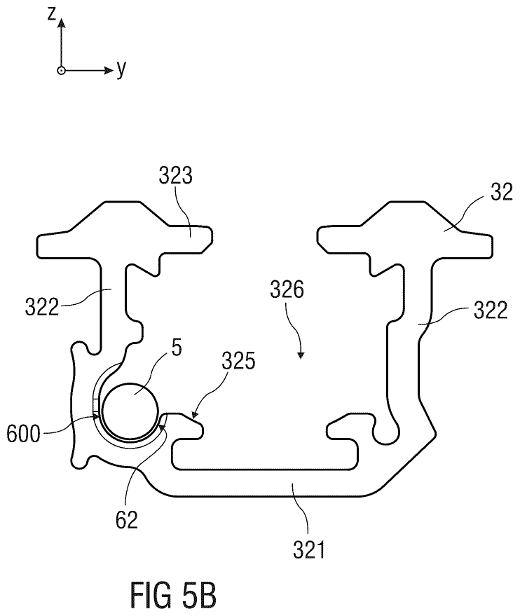

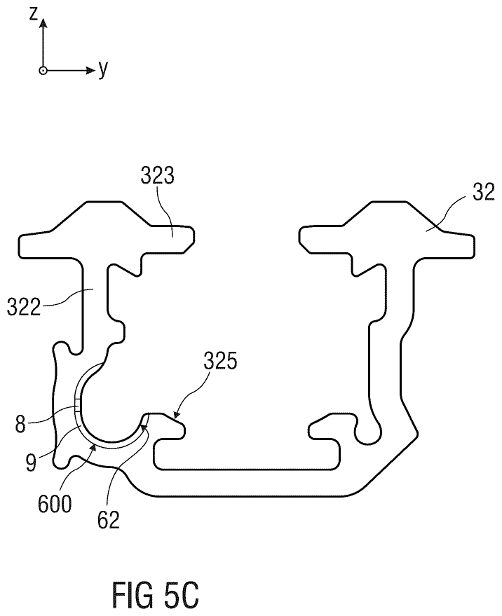

FIGS. 5A to 5C show schematic sectioned views of another embodiment of a rail pair, wherein one of the rails of the rail pairs has a receiving profile for receiving and guiding a cable, cable bundle or cable housing.

Mutually corresponding components are given the same reference numerals in all the Figures.

FIG. 1 is a schematic, perspective illustration of a seat 1, in particular a vehicle seat 1, having a longitudinal seat adjustment device 2. The seat 1 is arranged by means of the longitudinal seat adjustment device 2, for example, on a vehicle body which is not illustrated in greater detail.

A vehicle seat 1 which is schematically illustrated in FIG. 1 is described below using three spatial directions which extend perpendicularly to each other. A longitudinal direction X extends in a vehicle seat 1 which is installed in the vehicle substantially in a horizontal manner and preferably parallel with a longitudinal vehicle direction which corresponds to the usual travel direction of the vehicle. A transverse direction Y which extends perpendicularly to the longitudinal direction X is also orientated in a horizontal manner in the vehicle and extends parallel with a transverse vehicle direction. A vertical direction Z extends perpendicularly to the longitudinal direction X and perpendicularly to the transverse direction Y. With a vehicle seat 1 which is installed in the vehicle, the vertical direction Z preferably extends parallel with a vertical vehicle axis.

The position indications and direction indications used, such as, for example, front, rear, upper and lower, refer to a viewing direction of a passenger seated in the vehicle seat 1 in a normal seating position, wherein the vehicle seat 1 is installed in the vehicle, is in a position for use suitable for transporting persons, with an upright backrest and is orientated in conventional manner in the travel direction. However, the vehicle seat 1 may also be installed or moved in a different orientation, for example, counter to the travel direction.

The longitudinal seat adjustment device 2 comprises, for example, two rail pairs 3 which are arranged with spacing from each other. The respective rail pair 3 comprises two rails 31, 32 which are movable relative to each other. For example, the respective rail pair 3 comprises a rail 31 which is in the form of a seat rail and a rail 32 which is in the form of a base rail. The rail 32 is, for example, a lower rail, also referred to as a guide rail. The rail 31 is, for example, an upper rail, also referred to as a rail runner. For better understanding of the further description, the rail 31 is referred to below as an upper rail 31 and the rail 32 as a lower rail 32.

The upper rail 31 is arranged between a front end position and a rear end position so as to be longitudinally adjustable on the lower rail 32. This adjustability enables a longitudinal adjustment of the position of the seat 1, wherein the front end position of the upper rail 31 is associated with the foremost position of the seat 1 and the rear end position of the upper rail 31 is associated with the rearmost position of the seat 1.

The longitudinal seat adjustment device 2 comprises, for example, a locking element which is not illustrated in greater detail. In this instance, each rail pair 3 may comprise an associated locking element.

The longitudinal seat adjustment device 2 comprises at least one adjustment unit 4 for longitudinal adjustment of the seat 1.

In a further development, for example, the seat 1 is provided with a number of safety components 10. Safety components 10 are, for example, airbags, belt tensioners, for example, pyrotechnically drivable belt tensioners, and/or belt alarms.

FIG. 2 shows a schematic sectioned illustration through a rail pair 3 of the longitudinal seat adjustment device 2.

The longitudinal seat adjustment device 2 comprises, for longitudinal adjustment of the seat 1, at least one adjustment unit 4. The adjustment unit 4 comprises, for example, as adjustment elements 41, at least two rolling elements, for example, sliding rollers or sliding cylinders. Furthermore, the adjustment unit 4 comprises, for example, a drive unit which drives the adjustment elements 41 and which is not illustrated in greater detail, for example, a motor. Alternatively, the adjustment unit 4 is activatable manually. The longitudinal adjustment of the seat 1 may, for example, be carried out manually.

The upper rail 31 and the lower rail 32 are in each case configured in a U- shaped manner. The upper rail 31 is configured in a U-shaped manner and arranged in an inverted state in the lower rail 32. In the assembled position of the upper rail 31 on the lower rail 32, they delimit a hollow space 33 inside the longitudinal seat adjustment device 2.

The fixed lower rail 32 has a substantially U-shaped cross section, wherein the lower rail 32 comprises a web 321, referred to below as the base wall 321 or also rail base, and two side walls 322. The side walls 322 are raised upward from the base wall 321 and extend parallel with each other. Ends 323 of the side walls 322 are directed inward, in particular bent, and in each case form an upper support wall. The ends 323 are arranged substantially parallel with the base wall 321. Between the ends 323 a free space, for example, a leg region, is formed for introducing a seat connection which is secured to the upper rail 31. The correspondingly free ends 323 of the side walls 322 form inner rolling faces 324, for example, contact faces, for the adjustment elements 41 which are arranged on the movable upper rail 31 and retain the upper rail 31 in a movable manner on the lower rail 32. The base wall 321 may have lower, inner, in particular oblique, rolling faces 325, on which additional adjustment elements 41 can roll.

For example, the lower adjustment elements 41 are main support rollers or main support drums, sliding rollers or sliding cylinders. The upper adjustment elements 41 are, for example, secondary rollers, in particular auxiliary support rollers or auxiliary support drums, sliding rollers or sliding cylinders.

The upper rail 31 is configured to be U-shaped in cross section and arranged in an inverted manner in the lower rail 32. An upper side of the upper rail 31 is in the assembled state arranged with spacing from the ends 323 of the side walls 322 of the lower rail 32. In order to ensure this spacing, the upper adjustment elements 41 which contact the rolling faces 324 and which roll on them are retained with resilient pretensioning on the upper rail 31.

The upper rail 31 comprises two side walls 312 which protrude downward from an upper wall 311 (with respect to the inverted arrangement of the U-shaped upper rail 31). The upper wall 311 is, for example, in the form of a web 311. The side walls 312 are in each case arranged in a structural space, for example, hollow space or receiving space 326 (illustrated in FIG. 3) between the ends 323 of the side walls 322 of the lower rail 32 and the base wall 321 thereof. As a result of the lower adjustment elements 41, the upper rail 31, in particular the upper wall 311 and side walls 312 thereof, are arranged with spacing from the base wall 321 of the lower rail 32 and retained thereon so as to be movable. The lower rail 32 thus forms between the two side walls 322 thereof the receiving space 326 for the upper rail 31 and adjustment unit 4.

A longitudinal adjustment of the seat 1 with respect to the vehicle base is carried out via a longitudinal displacement of the upper rail 31 with respect to the lower rail 32. In this instance, the upper rail 31 and the lower rail 32 are in contact with each other only in specific guiding regions via the adjustment elements 41. As a result of at least one or more of these adjustment elements 41, for example, in the form of rolling elements, the upper rail 31 is during normal operation in the event of a longitudinal seat adjustment in the Z axis direction with respect to the lower rail 32 secured in a resiliently pretensioned manner and is movable in an X axis direction. In the remaining region, the lower rail 32 and the upper rail 31 are as a result of the bearing via the adjustment elements 41 resiliently pretensioned and consequently arranged in a play free manner with spacing from each other.

In order to supply power to the adjustment unit 4 and/or the safety components 10 and/or the upper rail 31 and/or the seat 1, the longitudinal seat adjustment device 2 is connected to a vehicle-side power source which is not illustrated in greater detail, for example, an on-board network, or to another power source, in particular a power supply unit. The power supply is carried out via a connection cable 5, for example, a power cable.

For safe guiding and retention of the connection cable 5 in the rail pair 3, the lower rail 32 comprises a receiving profile 6. The receiving profile 6 is formed by means of one of the side walls 322. In a further development, each of the side walls 322 comprises a receiving profile 6. The connection cable 5 may be in the form of a cable bundle with or without a cable housing.

The receiving profile 6 is in the form of a dovetail profile. The receiving profile 6 extends partially over the longitudinal extent of the lower rail 32 or over an entire length of the lower rail 32.

In other words: the corresponding side wall 322 comprises a dovetail profile or is in the form of a dovetail.

The receiving profile 6 is in the form of a recess or groove. The receiving profile 6 forms a hollow space in which the connection cable 5 is or can be arranged. The receiving profile 6 is formed by an inner side of the side wall 322. Alternatively, the receiving profile 6 may be a separate component which is secured to the corresponding side wall 322.

The corresponding side wall 322 or the receiving profile 6 comprises an inwardly protruding locking face 61. The locking face 61 forms, for example, a clamping face. The locking face 61 is, for example, in the form of a locking projection or locking hook. The locking face 61 protrudes obliquely downward and inward into the receiving space 326. The locking face 61 is, for example, arranged in a bending region between the corresponding side wall 322 and the inwardly bent end 323 of the lower rail 32. The upper locking face 61 is, for example, configured in a connection region between the rolling face 324 and the receiving profile 6. A lower locking face 62 is formed by the oblique rolling face 325. For example, the locking face 62 is formed in a connection region between the rolling face 325 and receiving profile 6. The connection cable 5 is thereby delimited in an upward and downward direction. The connection cable 5 is clamped or held tensioned by means of the locking face 62 in the receiving profile 6. The connection cable 5 is arranged in the receiving profile 6 in a form-fitting manner, in particular retained or tensioned. The connection cable 5 is arranged in the receiving profile 6 in a force-fitting manner, in particular retained or tensioned. Both side walls 322 may be formed with a receiving profile 6. For example, both side walls 322 are configured in an identical manner.

In the completely assembled state of the longitudinal seat adjustment device 2, the connection cable 5 is arranged between the side wall 322 of the lower rail 32 and a side wall 312 of the upper rail 31. The connection cable 5 is protected from external influences as far as possible.

The connection cable 5 has a shape which corresponds to the shape of the receiving profile 6. For example, the connection cable 5 is received in the receiving profile 6 as far as possible in a form-fitting manner and retained in a guided manner.

A cable profile 51 of the connection cable 5 has a dovetail shape. The cable profile 51 is surrounded by an aluminum profile of the receiving profile 6. The cable profile 51 is thus received in the receiving profile 6 which is in the form of an aluminum profile.

The cable profile 51 is, for example, provided at the outer side with a wear-resistant and/or low-friction coating 52 and/or flocking 53. For example, the connection cable 5 is configured in a flocked manner in order to reduce friction between the receiving profile 6 and the cable profile 51 and to compensate for tolerances. A play-free and rattle-free guiding of the connection cable 5 can thereby be ensured as far as possible.

FIG. 3 shows a schematic sectioned illustration of a lower rail 32 of the rail pair 3, wherein the lower rail 32 comprises an integrated receiving profile 6, in which a connection cable 5 is or can be arranged. The receiving profile 6 extends over an overall height of an inner wall of the lower rail 32. The receiving profile 6 has an upper locking face 61 and a lower locking face 62, which are arranged in a laterally offset manner with respect to the receiving profile 6, in particular in the direction of the receiving space 326. By means of the locking faces 61, 62, the connection cable 5 is clampable or tensionable in the receiving profile 6.

FIG. 4 schematically shows another embodiment of a lower rail 32 of the rail pair 3, wherein the lower rail 32 comprises an integrated receiving profile 60, in which a connection cable 5 is or can be arranged.

The receiving profile 60 illustrated in this instance is in the form of a guiding groove or guiding recess. For example, the receiving profile 60 is configured to be substantially U-shaped or tub-like in cross section. The receiving profile 60 is arranged in a lower portion of the side wall 322. The receiving profile 60 is configured to be open in an upward direction.

The corresponding side wall 322 or the receiving profile 60 comprises at least one locking face 63 which protrudes, for example, from the base wall 321 or in the region of the rolling face 325. The locking face 63 forms, for example, a clamping face. The locking face 63 is, for example, in the form of a locking projection or locking hook. The locking face 63 extends substantially parallel with the side wall 322. The receiving profile 60 is, for example, in the form of a guiding channel or guiding groove between the locking face 63 and the side wall 322. The connection cable 5 is thereby separated in the assembled state or in a state received in the receiving profile 60 from the receiving space 326 for receiving the upper rail 31 and laterally supported. The receiving profile 60 extends over an overall height of an inner wall of the lower rail 32. In this instance, the receiving profile 60 may receive differently configured connection cables 5, cable bundles or cable housings. In the exemplary embodiment illustrated, the connection cable 5 is when viewed in the vertical direction of the lower rail 32 arranged and retained in the lower portion of the receiving profile 60. The receiving profile 60 has at least the lower locking face 62 which is arranged in a laterally offset manner with respect to the receiving profile 60, in particular in the direction of the receiving space 326. The locking face 63 is arranged between the receiving profile 60 and the rolling face 325.

FIGS. 5A to 5C show schematic cross sections of another embodiment of a rail pair 3, wherein the lower rail 32 of the rail pair 3 has a receiving profile 600 for receiving and guiding a connection cable 5, cable bundle or cable housing. In this instance, FIG. 5A shows a rail pair 3 in the assembled state suitable for operation. FIG. 5B shows only the lower rail 32 with an introduced connection cable 5 and FIG. 5C shows the lower rail 32 without a connection cable 5.

The upper rail 31 and the lower rail 32 are configured in a U-shaped manner in each case. The upper rail 31 is configured in a U-shaped manner and arranged in an inverted state in the lower rail 32. In the assembled position of the upper rail 31 on the lower rail 32, they delimit a hollow space 33 inside the longitudinal seat adjustment device 2. In the exemplary embodiment shown, the upper rail 31 comprises a cover 7 which protects the hollow space 33 from external influences.

The fixed lower rail 32 comprises a base wall 321 and two side walls 322. The side walls 322 are raised upward from the base wall 321 and extend parallel with each other. The ends 323 of the side walls 322 are directed inward, in particular bent, and in each case form an upper support wall. The ends 323 are arranged substantially parallel with the base wall 321. The free ends 323 of the side walls 322 form internal rolling faces 324, for example, contact faces, for the adjustment elements 41 which are arranged on the movable upper rail 31 and which retain the upper rail 31 on the lower rail 32 in a movable manner. The base wall 321 may have lower, internal, in particular oblique, rolling faces 325 on which additional adjustments elements 41 can roll.

For example, the lower adjustment elements 41 are main support rollers or main support drums, sliding rollers or sliding cylinders. The upper adjustment elements 41 are, for example, secondary rollers, in particular auxiliary support rollers or auxiliary support drums, sliding rollers or sliding cylinders.

The upper rail 31 comprises two side walls 312 which protrude downward from an upper wall 311 (with respect to the inverted arrangement of the U-shaped upper rail 31). The side walls 312 are in each case arranged in a structural space, for example, hollow space or receiving space 326, between the ends 323 of the side walls 322 of the lower rail 32 and the base wall 321 thereof. As a result of the lower adjustment elements 41, the upper rail 31, in particular the upper wall 311 and side walls 312 thereof, is arranged with spacing from the base wall 321 of the lower rail 32 and retained in a movable manner thereon. The lower rail 32 thus forms between the two side walls 322 thereof the receiving space 326 for the upper rail 31 and adjustment unit 4.

A longitudinal adjustment of the seat 1 with respect to the vehicle base is carried out via a longitudinal displacement of the upper rail 31 with respect to the lower rail 32. As a result of at least one or more of these adjustment elements 41, for example, in the form of rolling elements, the upper rail 31 is during normal operation in the case of a longitudinal seat adjustment in the Z axis direction secured so as to be resiliently pretensioned with respect to the lower rail 32 and movable in the X axis direction. In the remaining region, the lower rail 32 and the upper rail 31 are arranged in a resiliently pretensioned manner and consequently in a play-free manner with spacing from each other as a result of the bearing via the adjustment elements 41.

In order to supply power to the adjustment unit 4, it is connected to a vehicle-side power source which is not illustrated in greater detail, for example, an on-board network. The power supply is carried out via at least one connection cable 5, for example, a power cable.

For secure guiding and retention of the connection cable 5 in the rail pair 3, the lower rail 32 comprises a receiving profile 600. The receiving profile 600 is formed by one of the side walls 322. In a further development, each of the side walls 322 comprises a receiving profile 600. The connection cable 5 may be in the form of a cable bundle with or without a cable housing.

The receiving profile 600 is configured in a C-shaped manner. The receiving profile 600 extends partially over the longitudinal extent of the lower rail 32 or over an entire length of the lower rail 32. The receiving profile 600 is in the form of a guiding groove which is formed by the side wall 322. The receiving profile 600 is, for example, formed by a recess formed in the side wall 322. The receiving profile 600 is, for example, suitable for receiving and guiding round cables, round cable bundles or round cable housings. The receiving profile 600 is in the form of a recess or groove. The receiving profile 600 forms a hollow space in which the connection cable 5 is or can be arranged. The receiving profile 600 is formed by an inner side of the side wall 322. Alternatively, the receiving profile 600 may be a separate component which is secured to the corresponding side wall 322. In the exemplary embodiment illustrated, the receiving profile 600, when viewed in a vertical direction of the lower rail 32, is arranged in a lower portion of the side wall 322.

A lower locking face 62 is formed by the oblique rolling face 325. For example the locking face 62 is formed in a connection region between the rolling face 325 and the receiving profile 600. The connection cable 5 is thereby delimited in a downward direction and to the side. The connection cable 5 is retained by means of the locking face 62 in the receiving profile 600 in a form-fitting manner. In a further development, the connection cable 5 may be retained in a clamped or tensioned manner by means of the locking face 62. Both side walls 322 may be formed with a receiving profile 600. For example, both side walls 322 are configured in an identical manner.

In the completely assembled state of the longitudinal seat adjustment device 2, the connection cable 5 is arranged between the side wall 322 of the lower rail 32 and a side wall 312 of the upper rail 31. The connection cable 5 is protected from external influences as far as possible.

The connection cable 5 has a shape which corresponds to the shape of the receiving profile 600. For example, the connection cable 5 is received in the receiving profile 600 in a form-fitting manner as far as possible and retained in a guided manner. The receiving profile 600 may be provided with a wear-resistant and/or low-friction coating 8 and/or flocking 9.

### LIST OF REFERENCE NUMERALS

1 Seat, vehicle seat
2 Longitudinal seat adjustment device
3 Rail pair
31 Rail, for example, upper rail
311 Web, in particular upper wall
312 Side wall
32 Rail, for example, lower rail
321 Web, in particular base wall
322 Side wall
323 End
324, 325 Rolling face
326 Receiving space
33 Hollow space
4 Adjustment unit
41 Adjustment element
5 Connection cable
51 Cable profile
52 Coating
53 Flocking
6, 60, 600 Receiving profile
61, 62, 63 Locking face
7 Cover
8 Coating
9 Flocking
10 Safety component
X Longitudinal direction
Y Transverse direction
Z Vertical direction

1-15. (canceled)

16. A rail for a rail pair of a longitudinal seat adjustment device, comprising at least two side walls and a web which connects the side walls, wherein at least one of the side walls has a receiving profile for receiving and guiding a connection cable or cable bundle or cable housing along a longitudinal extent of the rail, wherein the side wall has at least one locking face and the receiving profile is in the form of a guiding channel or guiding groove between the locking face and the side wall.

17. The rail as claimed in claim 16, wherein between the side walls and the web a receiving space is formed and the receiving profile faces in the direction of the receiving space.

18. The rail as claimed in claim 17, wherein in the receiving space at least one rolling face is provided for an adjustment element.

19. The rail as claimed in claim 17, wherein the receiving profile when viewed in the transverse direction of the rail is arranged in a laterally offset manner with respect to the rolling face.

20. The rail as claimed in claim 16, wherein the receiving profile is in the form of an inner wall profile of the side wall.

21. The rail as claimed in claim 16, wherein the receiving profile is dovetail-like or tub-like.

22. The rail as claimed in claim 16, wherein the receiving profile is in the form of a hollow bar or guiding groove.

23. The rail as claimed in claim 16, wherein the locking face is constructed to support the connection cable, cable bundle or cable housing in the transverse direction of the rail.

24. The rail as claimed in claim 16, wherein the receiving profile is formed on an inner face of the side wall.

25. The rail as claimed in claim 16, wherein the receiving profile is in the form of a separate profile element which at an inner face of the side wall is connected thereto by a material bond, force-fit and/or form-fit.

26. The rail as claimed in claim 16, wherein the receiving profile extends partially over a longitudinal extent of the rail or over an entire length of the rail.

27. The rail as claimed in claim 16, wherein the receiving profile has ends which are open toward end faces of the rail for introducing the connection cable.

28. The rail as claimed in claim 16, wherein the receiving profile extends at least partially over an entire height of the side wall.

29. The rail as claimed in claim 16, wherein the rail pair comprises an additional rail where the rail and the additional rail are adjustable relative to each other.

30. The longitudinal seat adjustment device for a vehicle seat, comprising the rail pair as claimed in claim 29.
